(19) United States
(12) Patent Application Publication
(10) Pub. No.: US 2008/0307159 A1
(43) Pub. Date: Dec. 11, 2008

(54) Method and control device for operating a non-volatile memory, in particular for use in motor vehicles

(76) Inventors: Joern Boettcher, Abstatt (DE); Jens Liebehenschel, Liederbach (DE); Markus Schmid, Stuttgart (DE)

Correspondence Address: KENYON & KENYON LLP, ONE BROADWAY, NEW YORK, NY, 10004, US

(21) Appl. No.: 12/156,979

(22) Filed: Jun. 6, 2008

(30) Foreign Application Priority Data
Jun. 8, 2007 (DE) 102007026690.3-53

(51) Int. Cl. G06F 12/02

(52) U.S. Cl. 711/103; 711/E12.008

(57) ABSTRACT

A method for the consecutive writing of performance quantity data to a non-volatile memory, in particular in a control device in a motor vehicle. The method encompasses the operations of determining a write address, which defines an address space for the writing of a performance quantity datum to be written, the address space being directly contiguous with a memory area occupied by a previously written performance quantity datum, and of writing the performance quantity datum to be written, to the address space of the non-volatile memory defined by the write address. In the determination operation, the write address corresponds directly to an address datum assigned to the most recently written performance quantity data, which is stored in a referencing datum in the non-volatile memory, or it is determined therefrom with the aid of an address offset that is independent of the size of the previously written performance quantity data.

### RELATED APPLICATION INFORMATION

The present application is based on priority German patent application no. 10 2007 026 690.3-53, which was filed in Germany on Jun. 8, 2007, the disclosure of which is incorporated herein by reference.

The present application also relates to co-pending U.S. patent application Ser. No. ______, which is being filed on the same date as the present application and which is Attorney Docket No. 10191/5578, which is based on priority German patent application no. 10 2007 026 691.1, which was filed in Germany on Jun. 8, 2007, the disclosure of which is incorporated herein by reference.

The present application also relates to co-pending U.S. patent application Ser. No. ______, which is being filed on the same date as the present application and which is Attorney Docket No. 10191/5579, which is based on priority German patent application no. 10 2007 026 693.8-53, which was filed in Germany on Jun. 8, 2007, the disclosure of which is incorporated herein by reference.

### FIELD OF THE INVENTION

The present invention relates to a method and a control device for operating non-volatile memories, in particular flash memories, for use in the automotive sector, for example.

### BACKGROUND INFORMATION

Control devices for the automotive sector are generally used to control and monitor functions of the vehicle engine and/or additional electrical systems in the motor vehicle. Such a control device may be equipped with a non-volatile memory in order to store various performance quantities and the like on a permanent basis, i.e., even when no supply voltage is applied, so that the control unit can access data from the past as well.

The demands on components used in the automotive sector are very high, however, and in general require extremely high reliability during the entire service life of the motor vehicle. The demands on the non-volatile memories used in automotive control devices are therefore high as well. Flash memories are normally utilized as non-volatile memories for automotive control devices. Because of the degradation effects of the flash memory cells, the service life of a flash memory cell is limited to a specific number of write cycles. The manufacturer usually guarantees a particular number of write cycles for a flash memory for a specific overall operating period of the motor vehicle during which said control unit is in operation.

In an effort to reduce the frequency at which a specific memory cell of the non-volatile memory is overwritten in a control device, the size of the memory in the control device is increased, and performance quantities to be stored therein are written to the memory area consecutively. This requires the implementation of an operating method by which the next free memory position in the non-volatile memory to be written thereafter is determined in order to then store the performance quantity there.

Currently, such an operating method is implemented by storing in the non-volatile memory the performance quantity data in a data segment, and by storing in a referencing segment of the non-volatile memory an address datum to which an indication about a corresponding type of the performance quantity data is assigned. The address datum generally indicates a start address of the data space in which the type of the performance quantity data indicated in the referencing segment is stored. To determine a write start address of the data space in the non-volatile memory to be written to with additional performance quantity data, the address data of the most recently written data space from the referencing segment is identified, and the start address of the corresponding data segment written most recently is determined. By the subsequent retrieval of the data length of the most recently stored performance quantity data, the write start address is able to be determined, i.e., the address position from which point on the non-volatile memory has not yet been written to, together with the start address. An additional communication within the control device is required both for the retrieval of the data length information and the calculation of the write start address as start address for the data to be written subsequently, and may thus constitute a considerable processing load.

### SUMMARY OF THE INVENTION

Therefore, it is an object of the exemplary embodiments and/or exemplary methods of the present invention to provide a method and a control device by which a non-volatile, writeable memory is able to be operated in a simple manner.

This object may be achieved by the method described herein and by the control device described herein.

Further advantageous developments of the exemplary embodiments and/or exemplary methods of the present invention are also disclosed herein.

According to a first aspect, a method is provided for the consecutive writing of performance quantity data to a non-volatile memory, in particular in a control device in a motor vehicle. The method encompasses the steps of determining a write address, which defines an address space for the writing of a performance quantity datum to be written, the address space being contiguous with a memory area occupied by a previously written performance quantity datum, and of writing the performance quantity datum to be written, to the address space of the non-volatile memory defined by the write address. In the determination step, the write address corresponds directly to an address datum assigned to the most recently written performance quantity data, which is stored in a referencing datum in the non-volatile memory, or it is determined therefrom with the aid of an address offset that is independent of the size of the previously written performance quantity data.

The provided device makes it possible to operate the control device in an improved manner since the address space for the subsequent writing with performance quantity data may be determined without the use of a data length datum of the previously written performance quantity data. As a result, no processing or retrieval of a data length datum is required in the write operation in order to determine the address space of data to be written next.

Furthermore, a referencing datum may be written, which indicates an address datum about the written performance quantity data, which relates to the last written address of the address space.

According to one specific embodiment, the address datum may indicate an address position of the address space written to last, to which the performance quantity datum has been written.

The write address may correspond to a write start address, which corresponds to an address position of the address space for a first data byte of the performance quantity datum to be written.

According to an additional aspect, a control device is provided, in particular for use in a motor vehicle. The control device includes a control unit for the supply of performance quantity data, and a non-volatile memory for the consecutive storing of the performance quantity data. The control unit is designed to determine a write address, which defines an address space for the writing of a performance quantity datum to be written, the address space being immediately contiguous with a memory area occupied by a previously written performance quantity datum, and it is designed to write the performance quantity datum to be written, to the address space of the non-volatile memory defined by the write address. In the determination step, the write address corresponds directly to an address datum assigned to the most recently written performance quantity data, the address datum being stored in a referencing datum in the non-volatile memory, or the control unit being designed to determine it from the address datum with the aid of an address offset that is independent of the size of the previously written performance quantity data.

Furthermore, the control unit is designed to write a referencing datum that indicates an address datum about the written performance quantity data, the address datum relating to the last written address of the address space.

Specific embodiments of the present invention are explained in greater detail in the following text on the basis of the attached drawings.

### BRIEF DESCRIPTION OF THE DRAWINGS

FIG. 1 shows a block diagram of a control device having a control unit according to one specific embodiment of the present invention.

FIG. 2 shows an illustrating representation of the data structure in a non-volatile, writeable memory used by the control unit.

### DETAILED DESCRIPTION

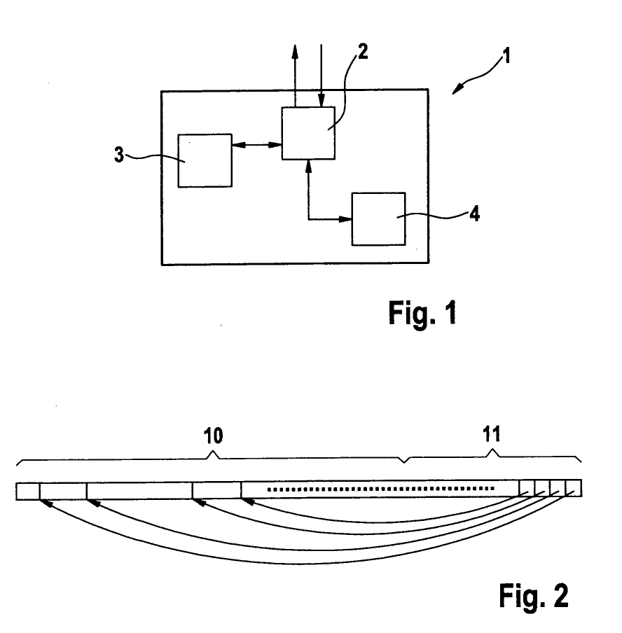

FIG. 1 shows a control device 1 for use in the automotive sector, for instance. Control device 1 includes a control unit 2. Control unit 2 carries out methods and calculations in order to implement a control of vehicle systems such as the engine control, the control of additional electrical systems in the motor vehicle and the like.

Control unit 2 is coupled to a program and static data memory 3, which stores program commands for implementing the control method executed by control unit 2, as well as static data that cannot be changed, e.g., constants, characteristic maps and the like. Static data memory 3 may be designed as non-volatile memory to which control unit 2 is unable to write in normal operation, e.g., a ROM, flash memory, EPROM, EEPROM and the like.

In the control of systems by control unit 2 it is often necessary to detect as performance quantity data information about the systems to be controlled, about environmental conditions and the like, to update this information and permanently hold the most recent performance quantity data in readiness, even over a period of time during which control device 1 is deactivated for a particular duration, i.e., is not supplied with a supply voltage. Data that are then stored in a working memory, such as a volatile read/write memory, e.g., a RAM, if applicable, are lost during such a period. For the long-term storing of performance quantity data, a non-volatile memory 4 to which control unit 2 may write, e.g., in the form of a flash memory or the like, and to which control unit 2 has access in order to store or read out specific performance quantities, is generally provided.

In order to reduce the loading of non-volatile memory 4 by frequent writing, the size of non-volatile memory 4 is greater than required for the storing of the performance quantities. However, this requires a memory management. In detail, performance quantity data to be stored are written to the address space of non-volatile memory 4 consecutively, i.e., in series.

FIG. 2 shows one example of a non-volatile memory 4 in schematic form. The memory area of memory 4 has a data area 10 and a referencing area 11. The data area may be located at a lower end of the logical (or physical) addresses of memory 4, and the referencing area is located at an upper end of the logical (or physical) addresses of memory 4. That is to say, consecutive performance quantity data are stored in temporal sequence at consecutive address positions, while the correspondingly assigned referencing data in the referencing area are stored in temporal sequence at decreasing addresses. In other words, non-volatile memory 4 is written with data from the one side and with referencing data from the other side.

A referencing datum contains information about the type of the performance quantity to be stored, as well as information about an address by which the position of the associated performance quantity in the memory space of non-volatile memory 4 is defined. When control unit 2 is writing to non-volatile memory 4, a write start address is determined first, which indicates the next available free memory location (in the form of an address) in non-volatile memory 4. Then, performance quantity data are written to the determined write start address. Once the performance quantity data have been written, a corresponding referencing datum is appended to the most recently written referencing datum in referencing area 11 of the non-volatile memory. As a rule, the referencing data are stored consecutively, in the same manner as the performance quantity data, but in a different memory location of the non-volatile memory.

Since the performance quantity data are written to the memory area in consecutive order, e.g., byte-by-byte or word-by-word (or in other data blocks having a low bit number=<32), i.e., consecutively with regard to their logical (or physical) addresses, the write start address at which the writing is to begin must be determined for the writing of the performance quantity data by control unit 2. This address may be ascertained in an especially simple manner if the most recently written referencing datum in referencing area 11 is read out as referencing datum, and if the memory address indicated there may be used to determine the start address, without requiring an indication about the size of the previously written performance quantity data. That is to say, in contrast to systems according to the related art which, in addition to a data length, require a start address of the previously written performance quantity data in order to determine the write start address for the writing of performance quantity data to be written, the method implemented by control unit 2 makes it possible to determine the write start address for the writing of the new performance quantity data without any indication of the data length of the performance quantity data.

The referencing datum may indicate the memory address most recently written by the previously written performance quantity data, or directly the write start address for the memory area that may be written to next. In this case the position of the previously written data may be determined nevertheless since the data area is being written to with the performance quantity data in direct succession, i.e., the data records of the performance quantity data immediately follow one another. Thus, having knowledge of the data length of the previously written performance quantity data, the indication of a start address for the writing of next performance quantity data makes it possible to determine their start address for a possible readout since the memory area adjacent to the write start address corresponds to the last byte of the previously written performance quantity data.

The method for operating a non-volatile memory may be executed by control unit 2. The method may be realized therein by a hardware implementation, an implementation with the aid of software that corresponds to a computer program, and also by a shared implementation by hardware and software.

In general, it is therefore provided to store in the referencing datum an address datum from which it is possible to ascertain a write start address for the writing of the next performance quantity data without retrieving or determining the data length of the previously written performance quantity data. Nevertheless, using such an address datum and having knowledge of the data length of the previously written performance quantity data, it is possible to determine the start address of the previously written performance quantity data in an unambiguous manner for readout.

What is claimed is:

1. A method for consecutively writing performance quantity data to a non-volatile memory, the method comprising:
determining a write address, which defines an address space for writing a performance quantity datum to be written, the address space being directly contiguous with a memory area occupied by a previously written performance quantity datum; and
writing the performance quantity datum to be written to the address space of the non-volatile memory defined by the write address;
wherein, in the determining, the write address corresponds directly to an address datum assigned to a most recently written performance quantity data, the address datum being one of (i) stored in a referencing datum in the non-volatile memory, and (ii) determined therefrom with an address offset that is independent of a size of the previously written performance quantity data.

2. The method of claim 1, wherein a referencing datum is written, which indicates an address datum about the written performance quantity data, the address datum relating to the address of an address space written to last.

3. The method of claim 1, wherein the address datum indicates an address position of an address space written to last, to which the performance quantity datum has been written.

4. The method of claim 1, wherein the write address corresponds to a write start address, which corresponds to an address position of the address space for a first data unit, which is one of a first data byte and a first data word, of the performance quantity datum to be written.

5. A control device for use in a motor vehicle, comprising:
a non-volatile memory to consecutively store performance quantity data; and
a control unit to supply the performance quantity data, wherein:
the control unit is configured to determine a write address, which defines an address space for writing a performance quantity datum to be written, the address space being directly contiguous with a memory space occupied by a previously written performance quantity datum, and to write the performance quantity datum to be written to the address space of the non-volatile memory defined by the write address, and
in the determining, the write address corresponds directly to an address datum assigned to the most recently written performance quantity data, the address datum being one of (i) stored in a referencing datum in the non-volatile memory and (ii) being determined therefrom by the control unit with an address offset that is independent of the size of the previously written performance quantity data.

6. The control device of claim 5, wherein the control unit is configured to write a referencing datum, which indicates an address datum about the written performance quantity data, the address datum relating to the address of the address space written to last.

7. The control device of claim 5, wherein the address datum indicates an address position of an address space written to last, to which the performance quantity datum has been written.

8. The control device of claim 5, wherein the write address corresponds to a write start address, which corresponds to an address position of the address space for a first data unit, which is one of a first data byte and a first data word, of the performance quantity datum to be written.

9. A computer readable medium having program code that is executable by a processor, comprising:
a program code arrangement for controlling a control unit to consecutively write performance quantity data to a non-volatile memory by performing the following:
determining a write address, which defines an address space for writing a performance quantity datum to be written, the address space being directly contiguous with a memory area occupied by a previously written performance quantity datum; and
writing the performance quantity datum to be written to the address space of the non-volatile memory defined by the write address;
wherein, in the determining, the write address corresponds directly to an address datum assigned to a most recently written performance quantity data, the address datum being one of (i) stored in a referencing datum in the non-volatile memory, and (ii) determined therefrom with an address offset that is independent of a size of the previously written performance quantity data.

10. The computer readable medium of claim 9, wherein a referencing datum is written, which indicates an address datum about the written performance quantity data, the address datum relating to the address of an address space written to last.

11. The computer readable medium of claim 9, wherein the address datum indicates an address position of an address space written to last, to which the performance quantity datum has been written.

12. The computer readable medium of claim 9, wherein the write address corresponds to a write start address, which corresponds to an address position of the address space for a first data unit, which is one of a first data byte and a first data word, of the performance quantity datum to be written.

13. The method of claim 1, wherein the non-volatile memory is in a control device in a motor vehicle.
